(19) United States
(12) Patent Application Publication
(10) Pub. No.: US 2026/0036263 A1
(43) Pub. Date: Feb. 5, 2026

(54) CONNECTION SPACE AND HYDROGEN SUPPLY ARRANGEMENT

(71) Applicant: LINDE GMBH, Pullach (DE)

(72) Inventors: Anton WELLENHOFER, Pullach (DE); Harald ZENZ, Pullach (DE); Petya TONEVA, Pullach (DE)

(21) Appl. No.: 18/994,412

(22) PCT Filed: Jul. 18, 2023
(86) PCT No.: PCT/EP2023/025336

§ 371 Date: Jan. 14, 2025

(30) Foreign Application Priority Data
Jul. 19, 2022 (EP) 22020346.7

(51) Int. Cl. F17C 13/12

(52) U.S. Cl. CPC F17C 13/126; F17C 2205/0314; F17C 2221/012; F17C 2221/014; F17C 2223/0123; F17C 2250/043; F17C 2250/0447; F17C 2260/038; F17C 2260/042; F17C 2270/0105

(57) ABSTRACT

A connection space for a hydrogen supply arrangement, having an inner region surrounded by the connection space for receiving components of the hydrogen supply arrangement, an inert gas supply device for flushing the inner region with an inert gas, and an exhaust gas system for discharging the inert gas from the inner region, wherein the inert gas supply device is designed to continuously supply the inert gas to the connection space and/or to maintain a constant inert gas pressure in the connection space.

The invention relates to a connection space for a hydrogen supply arrangement and to a hydrogen supply arrangement having such a connection space.

For the below-deck installation of liquefied natural gas (LNG) equipment for the operation of a ship, so-called tank connection spaces (TCS) are known internally. Components of the liquefied natural gas equipment, such as pipelines, valves, fittings, instrumentation or the like, are received in such a connection space. Air is pumped through the connection space to prevent LNG from accumulating in the event of a leak, which could lead to an explosive LNG-air mixture. The air exchange rate is selected so that the LNG concentration remains outside the explosion limit for LNG even in the event of a defined leak in one of the components within the connection space.

However, compared to LNG, hydrogen has a very wide explosion range. This means that hydrogen and air can form an explosive hydrogen-air mixture over a very wide range of hydrogen concentrations. For this reason, when using a connection space as stated above, very high air exchange rates are required, which can significantly increase the connection space compared to an application with LNG. In addition, a leak of cryogenic hydrogen in an air atmosphere can lead to a local condensation of air. This can lead to a local oxygen concentration, which promotes the ignition of hydrogen. The result is a local risk of explosion.

Against this background, an object of the present invention is to provide an improved connection space for a hydrogen supply arrangement.

Accordingly, a connection space for a hydrogen supply arrangement is proposed. The connection space comprises an inner region surrounded by the connection space for receiving components of the hydrogen supply arrangement, an inert gas supply device for flushing the inner region with an inert gas, and an exhaust gas system for discharging the inert gas from the inner region. The inert gas supply device is designed to continuously supply the inert gas to the connection space and/or to maintain a constant inert gas pressure in the connection space.

Because the inner region is flushed with the inert gas, there is no ignitability in the presence of hydrogen within the connection space. A minimal use of material and space is ensured for the connection space, since the formation of an ignitable hydrogen-air mixture is not to be expected and therefore explosion-proof equipment and fans for ventilating the connection space are not required.

The connection space is in particular a so-called cold box or can be referred to as such. The term “connection space” can thus be interchanged with the term “cold box” and vice versa. The connection space can, for example, have a cuboid or cube-shaped geometry with a floor, a plurality of side walls and a ceiling. However, the connection space can also be cylindrical. The connection space seals off the inner region from the environment of the connection space in a fluid-tight, in particular gas-tight manner.

The components of the hydrogen supply arrangement may comprise, for example, pipelines, apparatuses, valves, instrumentation, fittings or the like. The components are arranged within the connection space and thus in the inner region. The components or some of the components may be in fluid communication with a storage vessel for storing hydrogen via one or more pipelines. The storage vessel may be arranged inside or outside the connection space. The storage vessel can also be referred to as hydrogen storage vessel.

In addition to the connection space, the hydrogen supply arrangement preferably comprises the aforementioned storage vessel. The hydrogen supply arrangement is preferably designed to supply a consumer, in particular a fuel cell, with gaseous hydrogen. The consumer is supplied with gaseous hydrogen at a defined supply pressure, a suitable supply throughput and/or a defined supply temperature. For this purpose, the hydrogen can be evaporated upstream of the consumer.

The inert gas supply device is designed to continuously supply the inert gas, for example nitrogen, to the connection space and/or to maintain a constant inert gas pressure so that the entire inner region and/or the components are surrounded and/or flushed with the inert gas. In order to maintain a constant inert gas pressure in the connection space or in the inner region, a pressure sensor can be arranged within the connection space to monitor the inert gas pressure. For example, if the inert gas pressure drops, the inert gas supply device supplies inert gas to the connection space in order to keep the inert gas pressure at a constant or consistent value. Alternatively, the connection space can be continuously flushed with the inert gas. In this case, a constant volume flow of the inert gas can flow through the connection space. Monitoring the inert gas pressure is then unnecessary. The term “inert gas” can be interchanged with the term “nitrogen” and vice versa. However, other gases, such as carbon dioxide, can also be used as inert gases. The inert gas can also be referred to as a protective gas.

In this case, “flushing” the connection space or the inner region means that a continuous volume flow of the inert gas is passed through the inner region. Any hydrogen that may escape is discharged from the inner region together with the inert gas via the exhaust gas system. The exhaust gas system preferably comprises an exhaust gas line that leads out of the inner region. The inert gas and any hydrogen that may have escaped are removed via the exhaust gas line.

The “inert gas” discharged from the inner region by the exhaust gas system may be a mixture of the supplied inert gas and gaseous hydrogen. This means in particular that the term “inert gas” does not exclude the possibility that the inert gas discharged is a mixture of the supplied inert gas and gaseous hydrogen. However, in particular, the inert gas discharged only contains gaseous hydrogen if there is a leak in the inner region. Accordingly, the wording “exhaust gas system for discharging the inert gas from the inner region” may be interchanged with the wording “exhaust gas system for discharging the inert gas and/or gaseous hydrogen from the inner region”.

The connection space can be part of a vehicle. Accordingly, a vehicle having at least one such connection space is also proposed. The vehicle is preferably a watercraft, in particular a ship. For example, the vehicle may be a passenger ferry. In this case, the connection space may be located in a hull, in particular below a deck, of the vehicle. The vehicle may also be a land vehicle, for example a truck, a construction machine, a harvester, or the like. The vehicle may also be an aircraft. However, the connection space can also be used in immobile applications, for example in building technology.

In accordance with one embodiment, the exhaust gas system opens out of the connection space at a highest point of the inner region.

As previously stated, the connection space may have a ceiling. The ceiling can be pyramid-shaped or conical. Alternatively, the ceiling can also be flat. The exhaust gas line of the exhaust gas system opens out of the connection space at a highest point of this ceiling.

In accordance with a further embodiment, the exhaust gas system has a siphon at least partially filled with a liquid.

The liquid is preferably hydrogen-compatible. The liquid can therefore be described as a hydrogen-compatible liquid. For example, silicone oil can be used as a suitable liquid. The liquid seals the siphon. As an alternative to the siphon, a check valve can be used. The check valve may comprise a housing in which a non-return flap may be rotatably mounted at a pivot point. The non-return flap can be moved from a closed state to an open state and vice versa. In the closed state, the inert gas cannot flow through the check valve. In the open state, the inert gas can flow through the check valve. The non-return flap may be spring-loaded. This means that the non-return flap can be opened by the inert gas pressure of the inert gas. If the inert gas pressure falls below a predetermined value, the non-return flap closes again. For this purpose, the check valve may have a spring. The check valve may also be an electronic check valve. In this case, an actuator, for example an electric motor, is provided. The actuator opens and closes the non-return flap. The check valve can then be opened and closed, for example, based on a determined pressure difference. The check valve may also be a combination of a spring-loaded and an electronic check valve.

In accordance with a further embodiment, the siphon is arranged at least partially below a floor of the connection space.

This ensures that the functionality of the siphon is always maintained, even in rough seas, for example. In particular, a lowest point of the siphon is placed below the floor when viewed along a direction of gravity. The siphon is placed as low as possible. The siphon does not necessarily have to be arranged below the floor.

In accordance with a further embodiment, the connection space further comprises a sensor for monitoring the liquid collected in the siphon.

In this case, the term “collected” can be interchanged with the term “introduced” with reference to the liquid. In particular, the sensor is designed to check whether or not enough of the liquid has been collected in the siphon to seal the siphon. The sensor may be an optical sensor, for example. The sensor can in particular be designed to detect liquid levels of the liquid in the siphon. The sensor is in particular in operative connection with a control and regulation unit in the connection space. The operative connection can be wireless or wired. For example, the control and regulation unit can use a signal generator to emit a signal as soon as there is no longer enough liquid in the siphon.

In accordance with a further embodiment, the exhaust gas system has a bypass line which is guided around the siphon, wherein the bypass line is sealed by means of a rupture disk.

In particular, the bypass line connects a descending siphon part of the siphon with an ascending siphon part of the siphon above the liquid level of the liquid, wherein the bypass line acting as a connecting line between the siphon parts is sealed by means of the rupture disk. The bypass line is a bypass conduit and can therefore also be referred to as such. The siphon can be protected with the help of the rupture disk. If, for example, an unexpectedly high pressure occurs in the inner region, the rupture disk ruptures and the pressure reduction within the inner region occurs directly through the bypass line and not through the siphon.

In accordance with a further embodiment, the connection space is completely or partially surrounded by an insulating layer.

The insulating layer can completely or partially surround or envelop the connection space. In particular, an insulating layer is applied at least to the floor of the connection space. Such an insulating layer can also be provided on the ceiling and/or on one or more side walls of the connection space. Preferably, the insulating layer is attached to the outside of the connection space, in particular to the floor. This means in particular that the insulating layer faces away from the inner region. The insulating layer may be multilayer insulation (MLI). In the event of a leak of liquid hydrogen, for example, the insulating layer can prevent low-temperature embrittlement of a region of the vehicle on which the connection space is placed.

In accordance with a further embodiment, the connection space has a stainless steel layer facing the inner region.

In particular, the floor has a stainless steel layer facing the inner region. Such a stainless steel layer may also be provided on the ceiling and/or on one or more side walls of the connection space. Stainless steel is less susceptible to low-temperature embrittlement. The floor may be or have a stainless steel plate. The entire connection space may be made of stainless steel.

In accordance with a further embodiment, the inert gas supply device has an inert gas storage vessel, in particular a gas cylinder, and an inert gas supply line for supplying the inert gas from the inert gas storage vessel to the connection space.

A plurality of inert gas storages may be provided. In particular, if a pressure drop is detected within the inner region, the inert gas storage vessel can be replaced. The inert gas supply line may have a shut-off valve. This shut-off valve can be in operative connection with the aforementioned control and regulation unit.

In accordance with a further embodiment, the connection space further comprises an oxygen sensor, a hydrogen sensor and/or a pressure sensor, which are arranged in the inner region.

Preferably, the oxygen sensor, the hydrogen sensor and/or the pressure sensor are arranged at the aforementioned highest point of the inner region. These sensors can be in operative connection with the aforementioned control and regulation unit. As stated above, the pressure sensor can be used to maintain a constant inert gas pressure in the connection space or in the inner region.

In accordance with a further embodiment, the connection space has a flat, pyramid-shaped or conical ceiling.

As stated above, the exhaust gas system can be connected to a highest point or highest region of this ceiling. Furthermore, the oxygen sensor, the hydrogen sensor and/or the pressure sensor can also be provided in or at this highest region.

In accordance with a further embodiment, there is an overpressure in the inner region compared to an environment of the connection space.

The overpressure can be 100 mbar, for example. Whether or not there is an overpressure can be detected, for example, using the aforementioned pressure sensor. As soon as the overpressure in the inner region drops compared to the environment, it may be necessary to replace the inert gas storage vessel.

Furthermore, a hydrogen supply arrangement having such a connection space and components received in the inner region is proposed.

The hydrogen supply arrangement is in particular designed to supply a consumer as stated above, for example in the form of a fuel cell, with gaseous hydrogen. The components are the aforementioned various components of the hydrogen supply arrangement.

According to one embodiment, the hydrogen supply arrangement further comprises a storage vessel for receiving hydrogen, wherein the storage vessel is connected to the components by means of a pipeline.

The storage vessel is in particular a hydrogen storage vessel and can therefore also be referred to as such. The pipeline can, for example, be led from the environment to the inner region through a side wall of the connection space. In this case, the storage vessel is placed outside the connection space in the environment.

In accordance with a further embodiment, the storage vessel is arranged in the inner region.

This can also provide protection against a leak of the storage vessel itself. As stated above, the storage vessel can also be arranged outside the inner region and thus outside the connection space. In this latter case, the pipeline connecting the storage vessel to the components is passed through the connection space, in particular through one of the side walls of the connection space.

The embodiments and explanations given for the connection space apply accordingly to the hydrogen supply arrangement and vice versa.

In the present case, “a” is not necessarily to be understood as limiting to precisely one element. It is rather the case that several elements, such as two, three, or more, may also be provided. Any other number word used herein is also not to be understood as a limitation being given to precisely the number of elements mentioned. It is rather the case that, unless otherwise indicated, the number may deviate upwardly or downwardly.

Further possible implementations of the connection space and/or the hydrogen supply arrangement also include combinations that are not explicitly mentioned of features or embodiments described above or below with respect to the embodiments. A person skilled in the art will also add individual aspects as improvements or additions to the respective basic form of the connection space and/or the hydrogen supply arrangement.

Further advantageous embodiments and aspects of the connection space and/or the hydrogen supply arrangement are the subject of the dependent claims and of the embodiments of the connection space and/or the hydrogen supply arrangement described below. The connection space and/or the hydrogen supply arrangement are explained below in more detail with reference to the accompanying figures based on preferred embodiments.

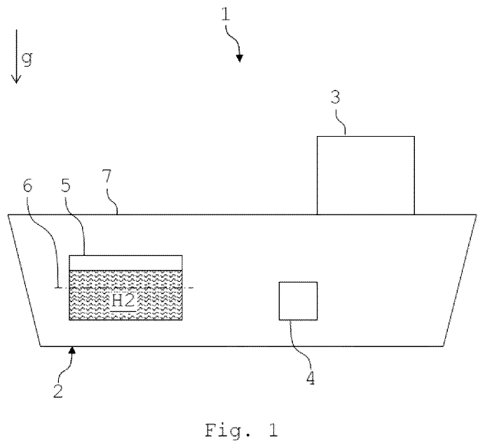

FIG. 1 is a schematic view of an embodiment of a vehicle;

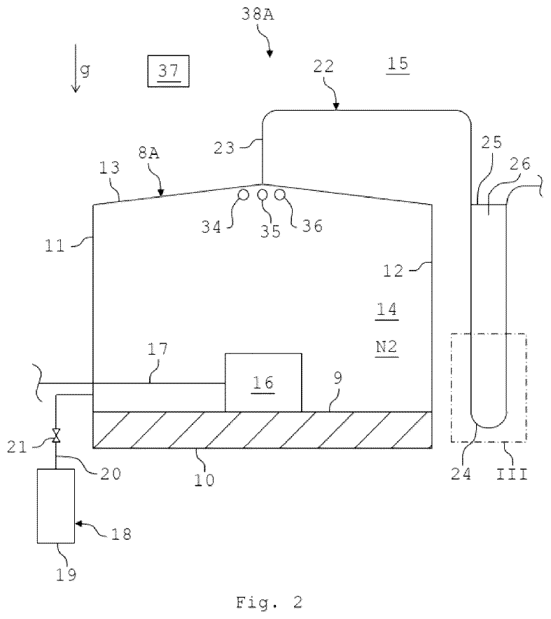

FIG. 2 is a schematic view of an embodiment of a connection space for the vehicle in accordance with FIG. 1;

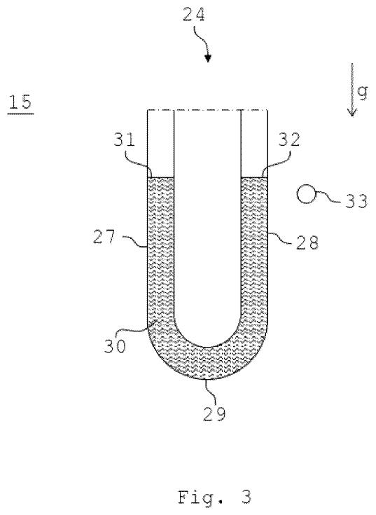

FIG. 3 shows the detailed view Ill in accordance with FIG. 2;

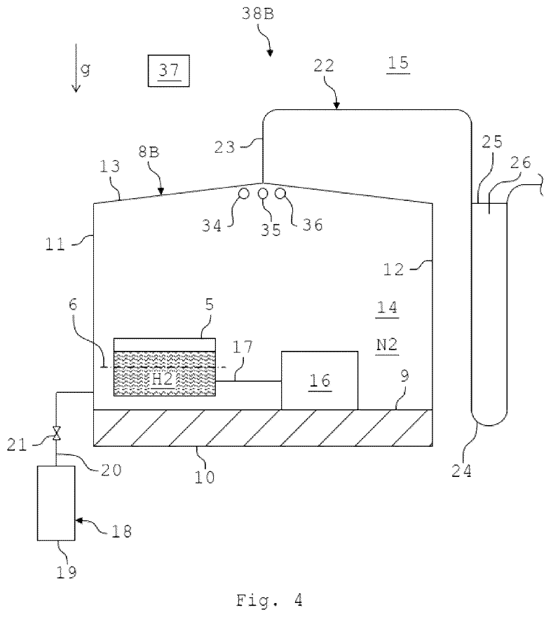

FIG. 4 is a schematic view of a further embodiment of a connection space for the vehicle in accordance with FIG. 1; and

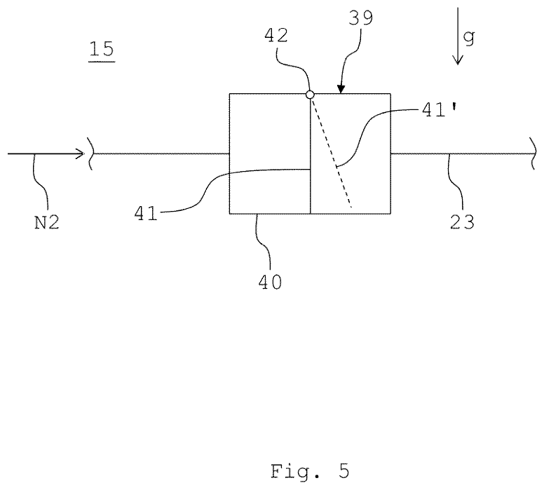

FIG. 5 is a schematic view of an embodiment of a check valve for the connection space in accordance with FIG. 1 or FIG. 4.

In the figures, the same or functionally equivalent elements have been provided with the same reference signs unless otherwise indicated.

FIG. 1 is a highly simplified schematic view of an embodiment of a vehicle 1.

The vehicle 1 can be, for example, a maritime watercraft, in particular a ship. The vehicle 1 can be referred to as a maritime vehicle. In particular, the vehicle 1 can be a maritime passenger ferry. Alternatively, the vehicle 1 can also be a land vehicle. However, it is assumed below that the vehicle 1 is a watercraft.

The vehicle 1 comprises a hull 2 that is buoyant. A bridge 3 is provided at or on the hull 2. The vehicle 1 is preferably powered by hydrogen. For this purpose, the vehicle 1 can have a fuel cell 4. In the present case, a “fuel cell” is understood to mean a galvanic cell that converts into electrical energy the chemical reaction energy of a continuously supplied fuel, in the present case hydrogen, and of an oxidant, in the present case oxygen. By means of the electrical energy obtained, an electric motor (not shown) can be powered, for example, which in turn drives a propeller for propelling the vehicle 1.

A storage vessel 5 for storing liquid hydrogen H2 is provided for supplying the fuel cell 4 with hydrogen. The storage vessel 5 is rotationally symmetrical with respect to a center axis or axis of symmetry 6. The storage vessel 5 may be arranged, for example, within the hull 2, in particular within an engine room. The storage vessel 5 is arranged under a deck 7 of the hull 2. The axis of symmetry 6 is oriented perpendicularly to a direction of gravity g. This means that the storage vessel 5 is in a lying or horizontal position. The axis of symmetry 6 is thus parallel to the deck 7. However, the storage vessel 5 may also be arranged upright or vertically. In this case, the axis of symmetry 6 is oriented parallel to the direction of gravity g.

FIG. 2 is a schematic view of an embodiment of a connection space 8A (tank connection space, TCS) for the vehicle 1.

The connection space 8A is a so-called cold box and can therefore also be referred to as such. The connection space 8A may be placed in the hull 2 below the deck 7. The storage vessel 5 is arranged outside the connection space 8A. However, the storage vessel 5 may also be arranged within the connection space 8A. However, it is assumed below that the storage vessel 5 is placed outside the connection space 8A.

The connection space 8A is preferably fluid-tight, in particular gas-tight. The connection space 8A has a floor 9. The floor 9 is preferably made of a stainless steel alloy. Instead of a stainless steel alloy, alternative materials that are resistant to low temperatures can also be used. In the orientation of FIG. 2, an insulating layer 10 is provided below the floor 9. The insulating layer 10 may be multi-layered. For example, the insulating layer 10 may be multilayer insulation (MLI). The insulating layer 10 may also comprise perlite or the like. The insulating layer 10 is in contact with a surface of the hull 2.

The connection space 8A may be cube-shaped or cuboid-shaped and, in addition to the floor 9, may have four side walls 11, 12, which can also be insulated. However, the connection space 8A may also be cylindrical or the like. In the upward orientation of FIG. 2, the connection space 8A is closed off by a ceiling 13, which can also be insulated. The ceiling 13 may be roof-shaped. In particular, the ceiling 13 may be pyramid-shaped or conical.

The connection space 8A surrounds an inner region 14 which is flushed with an inert gas N2, in particular with nitrogen. The connection space 8A separates the inner region 14 from the environment 15 of the connection space 8A in a fluid-tight manner. In the inner region 14 there is an overpressure compared to the environment 15. The overpressure can be 100 mbar, for example.

As stated above, the storage vessel 5 (not shown) is located outside the connection space 8A. However, any components 16 assigned to the storage vessel 5 are received in the inner region 14 of the connection space 8A. The components 16 may comprise, for example, pipelines, process engineering apparatuses, valves, instrumentation or the like. The storage vessel 5 may be in fluid communication with the components 16 via a pipeline 17. The pipeline 17 of the storage vessel 5 can be led from the environment 15 through the connection space 8A into the inner region 14. For example, the pipeline 17 is passed through one of the side walls 11, 12.

An inert gas supply device 18 is assigned to the connection space 8A. Using the inert gas supply device 18, the inner region 14 can be flooded and flushed with the inert gas N2. The inert gas supply device 18 comprises an inert gas storage vessel 19, for example a gas cylinder, an inert gas supply line 20 which leads from the inert gas storage vessel 19 to the connection space 8A, and a shut-off valve 21 with which the inert gas supply line 20 can be shut off and opened. The inert gas supply line 20 can, for example, be passed through one of the side walls 11, 12 and have further fittings, for example control valves.

An exhaust gas system 22 is provided for discharging the inert gas N2. The exhaust gas system 22 has an exhaust gas line 23 which opens out of the connection space 8A at a highest point of the connection space 8A, in particular at the ceiling 13. The exhaust gas line 23 leads to a siphon 24, the lowest point of which, when viewed along the direction of gravity g, is preferably placed below the floor 9. A bypass line 25 with a rupture disk 26 runs around the siphon 24. The exhaust gas line 23, the siphon 24 and/or the bypass line 25 can be double-walled or single-walled.

FIG. 3 shows the detailed view Ill in accordance with FIG. 2.

The siphon 24 is designed deep enough, when viewed along the direction of gravity g, to ensure that the siphon 24 is always sealed off from the environment 15, even in rough seas. The siphon 24 is formed by bending or arranging the exhaust gas line 23 in a loop-like manner. The siphon 24 comprises two portions 27, 28 running parallel to the direction of gravity g and a curved portion 29 which connects the two portions 27, 28.

The siphon 24 contains a hydrogen-compatible liquid 30 which seals the siphon 24. The liquid 30 may be a silicone oil or the like. In the portions 27, 28, the liquid 30 is at liquid levels 31, 32. A sensor 33 may be assigned to the siphon 24. The sensor 33 can be used to monitor the liquid 30 or liquid levels 31, 32. This means that the sensor 33 can, for example, monitor whether or not there is sufficient liquid 30 to seal the siphon 24. The sensor 33 may also be suitable for monitoring the liquid levels 31, 32. The sensor 33 thus serves to monitor the function of the siphon 24.

Now returning to FIG. 2, an oxygen sensor 34, a hydrogen sensor 35 and/or a pressure sensor 36 can be provided at a highest point of the connection space 8A, when viewed along the direction of gravity g, to which the exhaust gas line 23 is also connected. The sensors 34, 35, 36 are placed within the connection space 8A, i.e., in the inner region 14.

The sensors 33, 34, 35, 36 are operatively connected to a control and regulation unit 37 of the connection space 8A. The operative connection can be wireless or wired. The control and regulation unit 37 is also suitable for controlling the shut-off valve 21 and/or the components 16. For example, the control and regulation unit 37 may be suitable for opening and closing the shut-off valve 21.

The connection space 8A, the storage vessel 5, the pipeline 17 and the components 16 may be part of a hydrogen supply arrangement 38A for supplying the fuel cell 4 with hydrogen H2. During operation of the hydrogen supply arrangement 38A, the connection space 8A is flushed with the inert gas N2. The sensors 34, 35, 36 are used to monitor the oxygen content, the hydrogen content and the pressure within the inner region 14. The sensor 33 monitors the siphon 24. In the event of an unwanted pressure increase within the inner region 14, the rupture disk 26 ruptures or breaks and the inert gas N2 is passed past the siphon 24 through the bypass line 25.

FIG. 4 is a schematic view of a further embodiment of a connection space 8B.

The connection space 8B is part of a hydrogen supply arrangement 38B as stated above. The connection space 8B differs from the connection space 8A only in that the storage vessel 5 is arranged inside the connection space 8B rather than outside it. The functionality of the connection spaces 8A, 8B and the hydrogen supply arrangements 38A, 38B does not differ from one another.

Compared to liquefied natural gas (LNG), hydrogen H2 has a wide explosion range. During operation with LNG, in contrast to hydrogen H2, it is possible to work with a certain air exchange rate, which ensures that in the event of a leak in an LNG connection space (not shown), the LNG concentration remains outside the explosion limit for LNG. Ventilation can be carried out, for example, using fans with at least 30 air exchange cycles per hour.

However, the use of such an arrangement for use with hydrogen H2 has some disadvantages. Firstly, explosion analyses, in particular dynamic simulations, must be carried out to determine the spread of the explosive mixture formed with air. Many assumptions have to be made that do not accurately reflect the real state of the system. Furthermore, due to the high air exchange rates required in the case of hydrogen H2, the LNG connection space becomes very large. Furthermore, local condensation of air may occur, which can lead to a local hydrogen concentration that is above the ignition limit of the hydrogen-air mixture. The result is a local risk of explosion.

Using the connection space 8A, 8B explained above, these aforementioned disadvantages can be prevented or at least reduced. The connection space 8A, 8B allows hydrogen operation in a closed space, taking into account the special features of a maritime application, such as so-called sloshing effects, and ensuring an inert atmosphere, in particular with an oxygen content of less than 5 percent by volume, in the closed connection space 8A, 8B.

The advantages of operating in the inert environment within the connection space 8A, 8B are that, on the one hand, no explosions have to be taken into account. On the other hand, no ignition zone in accordance with ATEX (French: Appareils destinés n être utilisés en Atmosphéres Explosibles) has to be taken into account, since there is no ignitability. A minimal use of material and space is ensured, as there is no risk of explosion to be taken into account. Explosion-proof equipment and fans are not required. This results in a reduction in costs. The thermal insulation of the connection space 8A, 8B by means of the insulating layer 10 provides protection against low-temperature embrittlement in the event of a possible leak of liquid hydrogen H2.

Advantageously, preventive explosion protection can be implemented in the closed connection space 8A, 8B. As stated above, the siphon 24 is designed deep enough to ensure that the siphon 24 is sealed off from the environment 15 even in rough seas. The rupture disk 26 acts as the final element to bypass the siphon 24 in an emergency. The sensor 33 can advantageously be used to monitor the liquid 30.

The exhaust gas line 23 can optionally be designed with a double wall, in particular in the form of a pipe-in-pipe construction. Optionally, leak detection by cold current detection is also possible in addition to hydrogen detection and pressure detection. The floor 9, the side walls 11, 12 and the ceiling 13 are insulated, with the insulating layer 10 on the floor 9 providing additional insulation. The thermal insulation is therefore improved on the floor 9. At least one uppermost material layer of the floor 9 is made of stainless steel. This can prevent low-temperature embrittlement. Hot gas lines, for example as part of the components 16, can be designed with a single wall.

The connection space 8A, 8B can thus function as a sealed cold box, in particular including a storage vessel 5 and thermal insulation of the connection space 8A, 8B against the vehicle 1, to protect against low-temperature embrittlement at a low flush flow, a monitoring concept and a special design of the siphon 24 including siphon protection with the aid of the rupture disk 26.

The advantages of operating under the inert gas N2 are that no explosions have to be taken into account and that no ignition zone in accordance with ATEX needs to be considered, since there is no ignitability. Furthermore, a minimal use of material and space is ensured, as no possible explosion has to be taken into account. No explosion-proof equipment is necessary and fans for ventilation of the connection space 8A, 8B are not required.

The connection space 8A, 8B can also be used for explosive media other than hydrogen H2 in the maritime sector. Any piping can be completely double-walled. Optionally, warm gas pipes can be designed with single walls. The exhaust gas system 22 is double-walled or single-walled. Optionally, cold current detection can be carried out. Different media for siphon sealing, such as silicone oil, Freezium or the like, can be used for the liquid 30.

FIG. 5 is a schematic view of an embodiment of a check valve 39.

The check valve 39 can be used as an alternative to the siphon 24 explained above. The check valve 39 is provided or mounted in or on the exhaust gas line 23. The check valve 39 can be combined with the bypass line 25 explained above, which has the rupture disk 26.

The check valve 39 comprises a housing 40 in which a non-return flap 41 is rotatably mounted at a pivot point 42. The non-return flap 41 can be moved from a closed state, which is shown with a solid line, to an open state, which is shown with a dashed line and designated by the reference sign 41′, and vice versa. In the closed state, the inert gas N2 cannot flow through the check valve 39. In the open state, the inert gas N2 can flow through the check valve 39.

The non-return flap 41 may be spring-loaded. This means that the non-return flap 41 can be opened by an inert gas pressure of the inert gas N2. If the inert gas pressure falls below a predetermined value, the non-return flap 41 closes again. For this purpose, the check valve 39 may have a spring.

The check valve 39 may also be an electronic check valve. In this case, an actuator, for example an electric motor, is provided. The actuator opens and closes the non-return flap 41. The check valve 39 can then be opened and closed, for example, based on a determined pressure difference. The check valve 39 may also be a combination of a spring-loaded and an electronic check valve.

Although the present invention has been described with reference to embodiments, it can be modified in many ways within the scope of the claims.

### REFERENCE SIGNS USED

1 Vehicle
2 Hull
3 Bridge
4 Fuel cell
5 Storage vessel
6 Axis of symmetry
7 Deck
8A Connection space
8B Connection space
9 Floor
10 Insulating layer
11 Side wall
12 Side wall
13 Ceiling
14 Inner region
15 Environment
16 Component
17 Pipeline
18 Inert gas supply device
19 Inert gas storage vessel
20 Inert gas supply line
21 Shut-off valve
22 Exhaust gas system
23 Exhaust gas line
24 Siphon
25 Bypass line
26 Rupture disk
27 Portion
28 Portion
29 Portion
30 Liquid
31 Liquid level
32 Liquid level
33 Sensor
34 Sensor/oxygen sensor
35 Sensor/hydrogen sensor
36 Sensor/pressure sensor
37 Control and regulation unit
38A Hydrogen supply arrangement
38B Hydrogen supply arrangement
39 Check valve
40 Housing
41 Non-return flap
41′ Non-return flap
42 Pivot point
g Direction of gravity
H2 Hydrogen
N2 Inert gas/nitrogen

1. A connection space 8 for a hydrogen supply arrangement, having an inner region surrounded by the connection space for receiving components of the hydrogen supply arrangement, an inert gas supply devices for flushing the inner region with an inert gas, and an exhaust gas system for discharging the inert gas from the inner region, wherein the inert gas supply device is designed to continuously supply the inert gas to the connection space and/or to maintain a constant inert gas pressure in the connection space.

2. The connection space according to claim 1, wherein the exhaust gas system opens out of the connection space at a highest point of the inner region.

3. The connection space according to claim 1, wherein the exhaust gas system has a siphon at least partially filled with a liquid.

4. The connection space according to claim 3, wherein the siphon is arranged at least partially below a floor of the connection space.

5. The connection space according to claim 3, further comprising a sensor for monitoring the liquid collected in the siphon.

6. The connection space according to claim 3, wherein the exhaust gas system has a bypass line which is guided around the siphon, and wherein the bypass line is sealed by means of a rupture disk.

7. The connection space according to claim 1, wherein the connection space is completely or partially surrounded by an insulating layer.

8. The connection space according to claim 1, wherein the connection space has a stainless steel layer facing the inner region.

9. The connection space according to claim 1, wherein the inert gas supply device has an inert gas storage vessel, in particular a gas cylinder, and an inert gas supply line for supplying the inert gas from the inert gas storage vessel to the connection space.

10. The connection space according to claim 1, further comprising an oxygen sensor, a hydrogen sensor and/or a pressure sensor, which are arranged in the inner region.

11. The connection space according to claim 1, wherein the connection space has a flat, pyramid-shaped or conical ceiling.

12. The connection space according to claim 1, wherein there is an overpressure in the inner region compared to an environment of the connection space.

13. A hydrogen supply arrangement having a connection space according to claim 1, and components received in the inner region.

14. The hydrogen supply arrangement according to claim 13, further comprising a storage vessel for receiving hydrogen, wherein the storage vessel is connected to the components by means of a pipeline.

15. The hydrogen supply arrangement according to claim 14, wherein the storage vessel is arranged in the inner region.
